(19) United States
(12) Patent Application Publication
(10) Pub. No.: US 2026/0086897 A1
(43) Pub. Date: Mar. 26, 2026

(54) DATA PREPARATION IN A WIRELESS COMMUNICATIONS SYSTEM

(71) Applicant: Lenovo (Singapore) Pte. Limited, Singapore (SG)

(72) Inventors: Emmanouil Pateromichelakis, Viersen (DE); Konstantinos Samdanis, Munich (DE)

(73) Assignee: Lenovo (Singapore) Pte. Limited, Singapore (SG)

(21) Appl. No.: 19/112,197

(22) PCT Filed: Nov. 10, 2022
(86) PCT No.: PCT/EP2022/081509

§ 371 Date: Mar. 14, 2025

(30) Foreign Application Priority Data
Oct. 3, 2022 (GR) 20220100810

(51) Int. Cl. G06F 11/07; H04L 1/1607; H04L 41/0895

(52) U.S. Cl. CPC G06F 11/0793; G06F 11/0709; H04L 1/1607; H04L 41/0895

(57) ABSTRACT

There is provided a data preparation configuration entity in a wireless communications system. The data preparation configuration entity comprises a transceiver arranged to receive (910), a request for application layer data processing management, the request comprising a requirement for managing raw data from at least one data source. The data preparation configuration entity comprises a processor arranged to configure (920), at least one parameter of a data preparation configuration based on the request for application layer data processing management, the at least one parameter comprising information for preparing the required data. Also relates to a data preparation entity.

### FIELD

The subject matter disclosed herein relates generally to the field of implementing data preparation in a wireless communication system. In particular the subject matter disclosed herein relates to implementing data preparation in a wireless communication platform, such as at the application enablement layer. This document defines in a wireless communication network a data preparation configuration entity; a data preparation entity; a method in a data preparation configuration entity; and a method in a data preparation entity.

### BACKGROUND

Analytics and Artificial Intelligence (AI)/Machine Learning (ML) is deployed in the 5G core network via the introduction of the Network Data Analytics Function (NWDAF). Consideration is given to the support of various analytics types that can be distinguished using different Analytics IDs e.g. “UE Mobility”, “NF Load”, which are elaborated upon further in the 3^{rd} Generation Partnership Project (3GPP) Technical Specification TS 23.288.

Each NWDAF may support one or more Analytics IDs and may have the role of: AI/ML inference called NWDAF Analytics Logical Function (AnLF); AI/ML training called NWDAF Model Training Logical Function (MTLF); or both. NWDAF AnLF (or simply AnLF) and NWDAF MTLF (or simply MTLF) represent logical functions that be deployed as standalone or in combination. AnLF that support a specific Analytics ID inference using an AI/ML model, subscribes to a corresponding MTLF that is responsible for training of the same AI/ML model used for the respective Analytics ID.

An Analytics ID, contained in a NWDAF, relies on various sources of data input including data from 5G core Network Functions (NFs), Application Functions (AFs), 5G core repositories, e.g., Network Repository Function (NRF), User Data Manager (UDM), etc., and Operations Administration and Maintenance (OAM) data, e.g., Performance Measurements (PMs)/KPIs, Configuration Management (CM) data, alarms, etc. An Analytics ID contained in AnLF may provide analytics output result towards 5G core NF, AF, 5G core repositories, e.g., UDM, User Data Repository (UDR) Analytical Data Repository Function (ADRF), or OAM Management Service (MnS) Consumer or Management Function (MF). MTLF and AnLF may exchange AI/ML models, e.g., via the means of serialization, containerization, etc., including related model information. Optionally, Data Collection Coordination Functionality (DCCF) and Messaging Framework Adaptor Function (MFAF) may be involved to distribute and collect repeated data towards or from various data sources.

Furthermore, analytics (which can be ML-enabled) is provided at the edge/application side, at Application Data Analytics Enabler Service (ADAES defined in 3GPP TR 23.700-36) or in general at application side (Vertical Application Layer (VAL) server or app), where data can be collected by multiple data sources (incl. 5GC, OAM, MEC, VAL layer, User Equipment (UE)). An ADAE server in certain deployments can reuse the existing 3GPP data analytics framework for the data collection coordination, delivery and storage.

Data preparation is a necessary step in the ML model lifecycle and is the process of preparing raw data so that it is suitable for further processing and analysis. Key steps include collecting, cleaning, and labelling raw data into a form suitable for machine learning (ML) algorithms, and then exploring and visualizing the data. According to ORAN (O-RAN. WG2.AIML v01.03) data preparation depends on the use case (i.e. analytics type) and AI/ML model architecture employed, and can have an impact on model performance.

Data preparation can also be used if there are similar data from heterogeneous data sources which need some preparations before exposure to the data consumer. This may be needed to assure the data quality, and if data is missing to perform pro-actively data recovery mechanisms, so as to avoid the data consumer (who may be the analytics function or an optimization function, for instance) having some impact by possible data quality issues. By way of example, a VAL server or UE can provide QoE data; SEALDD can provide QoE data; and OAM can also provide KPI monitoring data. The data preparation can format/process data received by different sources and can provide a unified set of data with the required data characteristics.

### SUMMARY

When employing ML-enabled analytics in 3GPP, some data preparation needs to be considered especially due to the fact that variety of data are collected from different types of sources including, UEs, network functions, management entities, applications. Such data may be used for ML model training and/or inference and it needs to be assured that the quality of the data is optimal in order to avoid model drifts.

Currently however, in the 3GPP architecture (considering both SA2 and SA6) there is no consideration regarding data preparation, which is the first step of analytics that significantly influences the analytics performance. Data preparation is responsible for (i) understanding the characteristics of data, i.e., collecting information about the data, e.g., type of data, range, etc., (ii) determining if the data suffers from quality issues, e.g., errors or missing values, and dealing with them and (iii) formatting and labelling data, preparing also the data set for training purposes. Data preparation can pre-process raw data from the UE, network and application source into a data format that can feed both AI/ML model training and inference phases. Raw data sources may include the following types of data: Numeric—values of real data that allow arithmetic operations; Interval—values that allow ordering and subtraction e.g. time windows; Ordinal-values that allow ordering but not arithmetic operations, e.g. Quality of Experience (QoS) being low, medium, high; Boolean-binary values, e.g. 0 and 1; Categorical—finite set of values that cannot be ordered or perform arithmetic operations, e.g. UE, MICO; Textual—free form text data, e.g. name or identifier.

Data preparation may also require guidance that provides support on how to deal with low data quality depending on the: i) analysis on the data characteristics, ii) type of the AI/ML Model that use such data, iii) availability of external tools or data sources. Such guidance may rely on input provided by 5G NFs, AFs including 3rd parties and other network tools.

Implementation specific solutions may rely on pre-configured or “closed” mechanisms to deal with data preparation or can be vendor specific. However, pre-configuration, “closed” or vendor specific solutions may fail to deal with unknown problems and may introduce overhead for preparing data that can be consumed only by specific NWDAFs, which cannot be shared with other vendors. Data preparation may also span over the two flavours of NWDAF, i.e., MTLF for training and AnLF for inference respectively, which can be deployed by different vendors. So, coordination of the configuration of data preparation may be needed and if no dedicated functionality exists, such logic needs to be present at both MTLF and AnLF introducing higher overhead. In addition, implementation specific solutions limit the interaction with other tools, e.g., digital twin or sandbox, or the interaction with 5G NFs, AF from 3rd parties and OAM (which can be offered by a different administrative player).

In summary, a poor and inaccurate data preparation can lower the performance of the AI/ML introducing model drift, while a data preparation with open control can be tailored based on the type of data, on the use of data for a given analytics event, type of the consumer, data source profile.

Whilst, the notion of formatting and/or processing in the current 3GPP architecture is introduced in DCCF/MFAF, which may be provided in requests by data consumers as described in clause 5A.4 in TS 23.288,—formatting and/or processing does not address the data preparation. Formatting determines when a notification is sent to the consumer, e.g., considering time of an event trigger, a process that has nothing to do with converting the data into a shape useful for the AI/ML model. On the other hand, processing instructions allow summarizing of notifications to reduce the volume of data reported to the data consumer. The processing results in summarizing of information from multiple notifications into a common report. Hence, processing also focuses on data collection optimization and not on data preparation use for an AI/ML model.

Additionally, whilst the notion of data preparation is introduced in ITU-T Y.3172 (06/2019) as a pre-processor node or logical entity that is responsible for cleaning data, aggregating data, or performing any other pre-processing needed for the data to be in a suitable form so that the ML model can consume it. ITU-T Y.3172 primarily discusses the ML-pipeline control, i.e., how to combine the pre-processor with other ML related entities. However, introducing a data preparation entity including the respective control with standardized interfaces to control the data preparation, i.e., allowing access and interaction with other NFs, AFs, OAM, tools, and 3rd parties, is still an open issue. Such data preparation and control can provide data sharing among various analytics functions (ADAES, NWDAF) and can enhance the solution options when data preparation is facing data quality issues. In addition, data preparation for the cases when the UE is the data source for real time data is a challenging task, which requires an intelligent and policy-based configuration to ensure that data collection from the UE is sufficient and timely provided to the network side to allow for accurate predictions.

Disclosed herein are procedures for data preparation in a wireless communication system. Said procedures may be implemented by a data preparation configuration entity in a wireless communication system; a data preparation entity in a wireless communication system; a method in a data preparation configuration entity, the data preparation configuration entity in a wireless communication system; and a method in a data preparation entity, the data preparation entity in a wireless communication system.

There is provided a data preparation configuration entity in a wireless communications system, comprising a transceiver arranged to receive a request for application layer data processing management, the request comprising a requirement for managing raw data from at least one data source; and a processor arranged to configure at least one parameter of a data preparation configuration based on the request for application layer data processing management, the at least one parameter comprising information for preparing the required data.

There is further provided a data preparation entity in a wireless communication system, comprising: a transceiver arranged to receive a data preparation configuration, the data preparation configuration comprising at least one parameter comprising information for preparing required data required from at least one data source, wherein the transceiver is further arranged to receive raw data from the at least one data source; a processor arranged to process the raw data based on the data preparation configuration; and wherein the processor is further arranged to control the transceiver to transmit a report indicating a data quality issue of the raw and/or processed data.

There is further provided a method in a data preparation configuration entity, the data preparation configuration entity in a wireless communication system, comprising: receiving a request for application layer data processing management, the request comprising a requirement for managing raw data from at least one data source; and configuring at least one parameter of a data preparation configuration based on the request for application layer data processing management, the at least one parameter comprising information for preparing the required data.

There is further provided a method in a data preparation entity, the data preparation entity in a wireless communication system, comprising: receiving a data preparation configuration, the data preparation configuration comprising at least one parameter comprising information for preparing required data required from at least one data source; receiving raw data from the at least one data source; processing the raw data based on the data preparation configuration; and transmitting a report indicating a data quality issue of the raw and/or processed data.

The data preparation configuration entity may be a network node of the wireless communication system which may include enablement layer/application layer entities within the extended notion of a network. The data preparation configuration entity may itself also be a data preparation entity. The data preparation entity may be at the UE/device side i.e. an application entity. The data preparation configuration entity and data preparation entity may be a capability of a new VAL data collection management function in some embodiments, and in further embodiments may be deployed as an enhanced new SEAL or SEALDD service.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for data preparation in a wireless communication system will now be described, by way of example only, with reference to the accompanying drawings, in which:

FIG. 1 illustrates an embodiment of a wireless communication system for data preparation;

FIG. 2 illustrates an embodiment of a user equipment apparatus for data preparation;

FIG. 3 illustrates an embodiment of a network node for data preparation;

FIG. 4 illustrates various NWDAF embodiments including respective inputs and outputs;

FIG. 5 illustrates an embodiment of a generic functional model for ADAE re-using existing data analytics models;

FIG. 6 provides an illustration of the general AI/ML procedures provided by ORAN;

FIG. 7 illustrates an embodiment of Service Enabler Architecture Layer (SEAL) Data Preparation Management (DPM);

FIG. 8 illustrates the data analysis and data processing operations included in the DPM function of FIG. 7;

FIG. 9 illustrates an embodiment of a method in a data preparation configuration entity;

FIG. 10 illustrates a further embodiment of a method in a data preparation configuration entity;

FIG. 11 illustrates an embodiment of a method in a data preparation entity; and

FIG. 12 illustrates a further embodiment of a method in a data preparation entity.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of Band C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

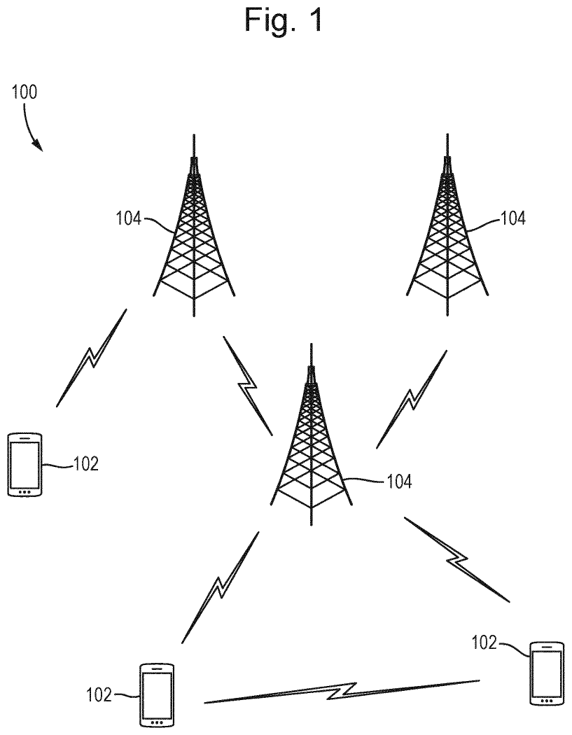

FIG. 1 depicts an embodiment of a wireless communication system 100 for data preparation in a wireless communication system. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by an other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

The disclosure herein provides data preparation configuration entities and data preparation entities that provide data preparation, in particular for AI/ML model training and/or inference data. Such entities and methods in said entities will be described herein using examples with particular reference to SEAL.

SEAL itself provides a set of capabilities at application layer for supporting the integration with verticals. Such services include Location Management, Group Management, Slice Enablement, Analytics enablement etc. SEAL is specified in 3GPP Technical Specification TS 23.434.

In SEAL, there are various reasons for collecting raw data from different domains. In particular, Network Slice Capability Enablement (NSCE) service (specified also in 3GPP TS 23.435) collects PM/FM data from OAM, performance data from the application of the UE, QoE data from the application specific server. Based on this data, it derives some slice related support services to the vertical customer (e.g. QoS verification, pro-active slice adaptation trigger etc.). In addition, Application Data Analytics Enablement Service (ADAES, specified in 3GPP TS 23.436) collects data from different data sources either directly or via A-DCCF, to perform analytics.

Also, for SEAL, the SEAL Data Delivery (SEALDD) service (specified in 3GPP TS 23.433) is introduced for processing user plane data (e.g., for caching, traffic optimization) between UE and application server. A possible new SEAL service, not yet specified, the VAL Data Collection Management Function, could be used to provide the data collection management services to other SEAL functions which require to collect data from a VAL client, or a VAL server, e.g., NSCE, ADAE, SEALDD, etc.

The disclosure herein described deals with the operations of data preparation that involve the pre-processing of raw data into a form that is ready to be used by the consumer of the data, which can be the AI/ML model (in case that analytics function is the consumer). Data preparation deals with two main types of data, continuous (i.e., data values as a function of time) and categorical (data that belongs to different categories or levels/states). It is the initial step in the network analytics and can include several different tasks such as loading of data from selected data sources, data analysis, data cleaning, data processing or modification and data augmentation. These tasks fall into the following main categories: i) data collection and analysis to identify irregularities, ii) data recovery and cleaning considering (a) systematic errors involving large data records from different data sources and/or (b) individual data errors due to random or processing errors, iii) data formatting and iv) data labelling and separation into sets for accommodating different training tasks. Data labelling is the process of identifying raw data and adding one or more meaningful and informative labels to provide context so that a machine learning model can learn from it. As example, the labelling of certain data samples can be labelled as “user data”or “QoE data”for instance.

The present application presents a solution to these problems.

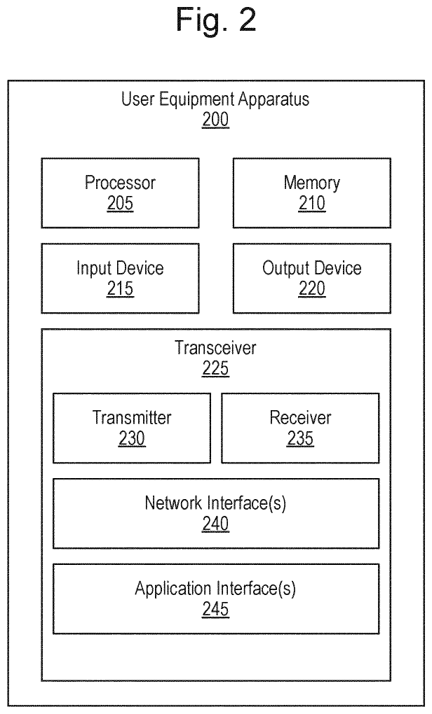

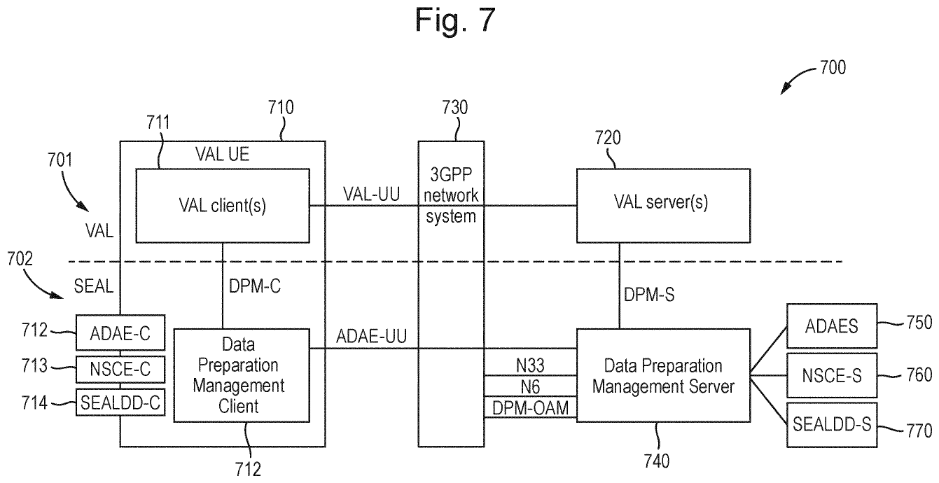

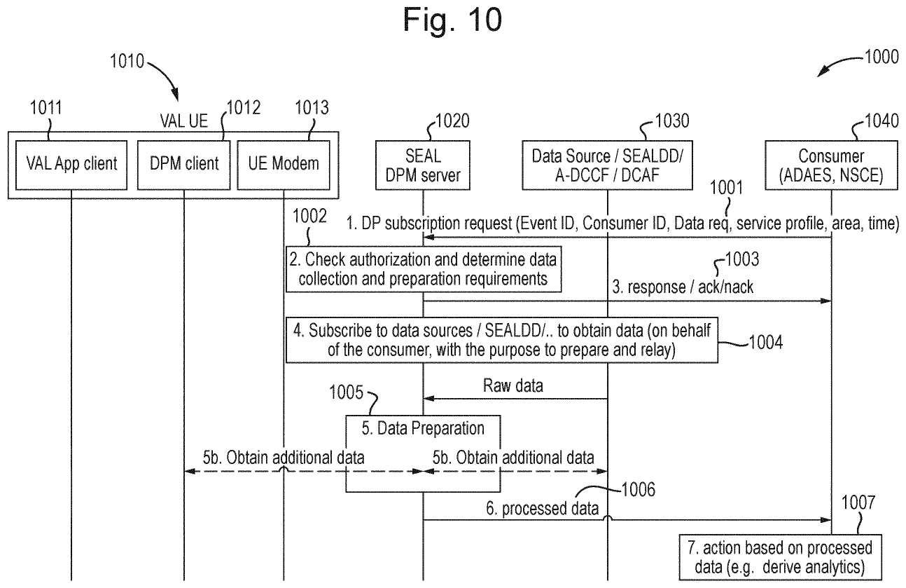

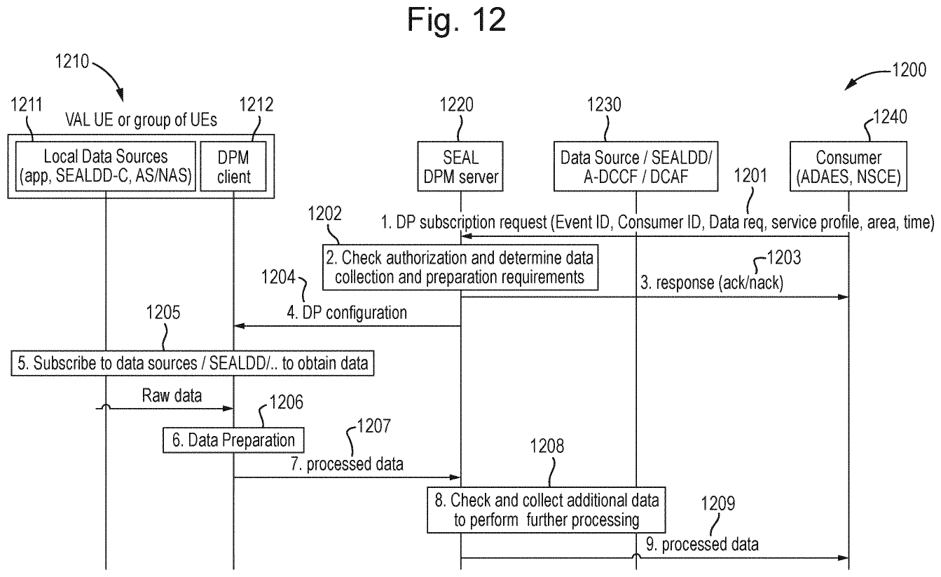

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 is in accordance with the 102 of FIG. 1, with 710 and 712 of FIG. 7, with 1010 of FIG. 10, and with 1210 of FIG. 12, and as such the reference numeral 200 is used hereinafter to indicate a user equipment apparatus in accordance with the 102, 710, 1010, and/or 1210. The user equipment apparatus 200 itself may be a data preparation entity. The user equipment apparatus 200 may comprise a DPM client for performing data preparation at the user equipment apparatus 200. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

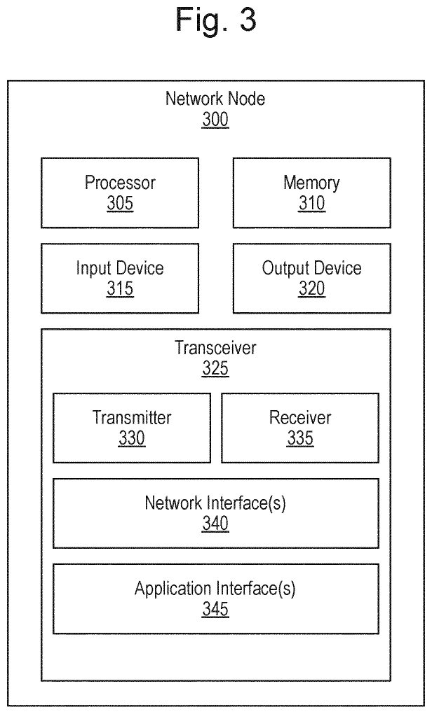

FIG. 3 depicts further details of the network node 300 that may be used for implementing the methods described herein. The network node 300 may be one implementation of an entity (such as a data preparation configuration entity and/or data preparation entity) in the wireless communications network, e.g. in one or more of the wireless communications networks described herein. The network node 300 may be, for example, the UE 200 described above, or a Network Function (NF) or Application Function (AF), or another entity, of one or more of the wireless communications networks of embodiments described herein, e.g. the nodes 104 of FIGS. 1, 720 and 740 of FIGS. 7, 1020 of FIGS. 10 and/or 1220 of FIG. 12. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

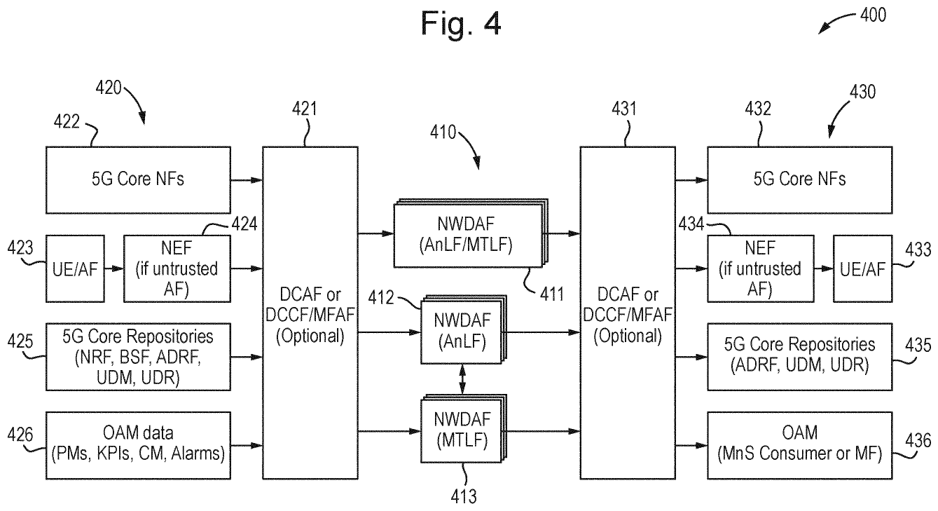

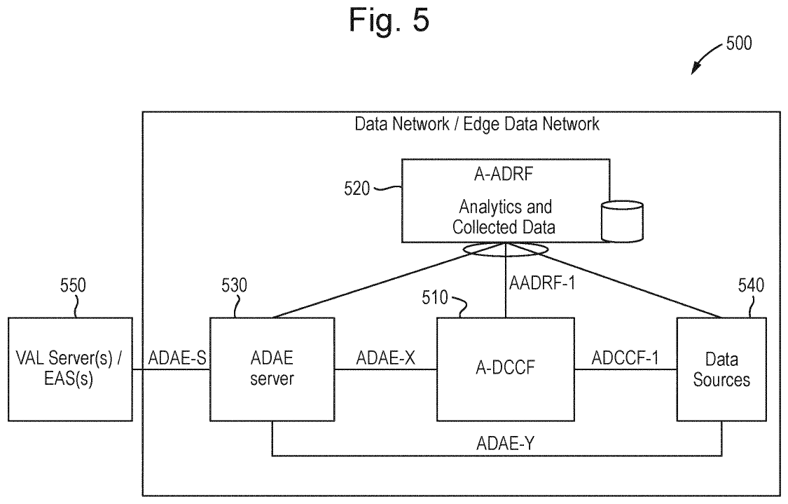

Network analytics and analytics data preparation involves the support of various analytics types, various input data sources and various output consumers of the analytics. To assist in understanding the breadth of network analytics to which the herein described invention may attend, FIG. 4 and FIG. 5 are provided by way of example only. FIG. 4 provides an illustration 400 of various NWDAF embodiments 410 alongside examples of their respective inputs 420 and outputs 430. The figure shows an NWDAF(AnLf/MTLF) 411, an NWDAF (AnLF) 412, and an NWDAF (MTLF) 413. These NWDAF types 410 receive inputs from DCAF or DCCF/MFAF 421, which itself is receiving inputs from 5G Core NFs 422, UE/AF 423 optionally via NEF 424, 5G core repositories 425 (such as NRF, BSF, ADRF, UDM, UDR), and OAM data 426 (such as PMs, KPIs, CM, Alarms). The figure also shows the NWDAF types 410 outputting to DCAF or DCCF/MFAF 431, which itself is outputting to 5G core NFs 432, UE/AF 433 optionally via NEF 434, 5G core repositories 435 (such as ADRF, UDM, UDR), and OAM 436 (such as MnS consumer or MF).

More specifically, an Analytics ID, contained in a NWDAF 410, relies on various sources of data input including data from 5G core NFs 422, AFs 423, 5G core repositories 425, e.g., NRF, UDM, etc., and OAM data, e.g., PMs/KPIs, CM data, alarms, etc. An Analytics ID contained in AnLF may provide analytics output result towards 5G core NF 432, AF, 5G core repositories 435, e.g., UDM, UDR ADRF, or OAM 436 MnS Consumer or MF. MTLF and AnLF may exchange AI/ML models, e.g., via the means of serialization, containerization, etc., including related model information. Optionally, DCCF and MFAF 421, 431, may be involved to distribute and collect repeated data towards or from the various data sources.

Furthermore, analytics (which can be ML-enabled) can be provided at the edge/application side, at an application data analytics enabler service or in general at application side, where data can be collected by multiple data sources (incl. 5GC, OAM, MEC, VAL layer, UE). The ADAE server in certain deployments can reuse the existing 3GPP data analytics framework for the data collection coordination, delivery and storage. FIG. 5 illustrates an embodiment 500 of such a generic functional model for ADAE using existing data analytics models. In this functional model 500, an Application layer Data Collection and Coordination Function (A-DCCF) 510 is used to fetch data or put data (including formatting) into an Application level entity (e.g. A-ADRF, Data Source) 520. Such an A-DCCF 510 coordinates the collection and distribution of data requested by ADAE server 530 (over ADCCF-1, ADAE-X). ADAE server 530 can also directly interact with the Data Sources 540 via ADAE-Y. Application layer-Analytics and Data Repository Function (A-ADRF) 520 can be used to store historical data and/or analytics, i.e., data and/or analytics related to past time periods that has been obtained by the ADAE server 530 (via AADRF-1) or other NFs/NWDAF. ADAE server 530 can also fetch historical data from ADRF 520. Whether the ADAE server 530 directly contacts the ADRF 520 or goes via the A-DCCF 510 is based on configuration. Data Sources 540 can be 5GS data sources (5GC, OAM) or enablement layer data sources (SEAL, EEL) or external data sources at the DN side (VAL server/EAS) 550 and VAL UEs. A-DCCF 510 and A-ADRF 520 can be used only for interacting with certain data sources 540 (e.g., 5GC, OAM) based on configuration, and can be hidden from the VAL layer.

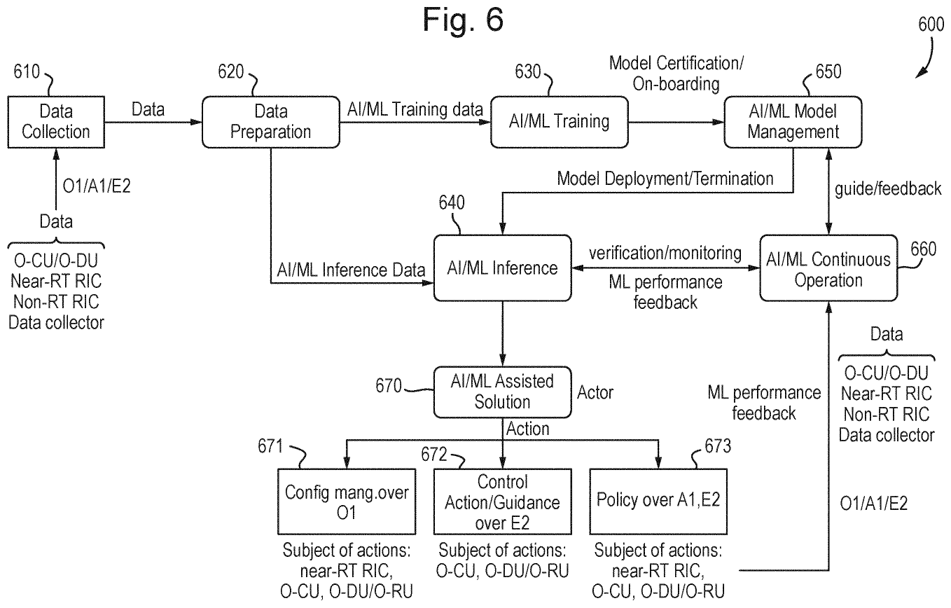

Certain procedural aspects of the application of AI/ML are provided by way of a background example using ORAN AI/ML prior art general procedures (O-RAN. WG2.AIML v01.03). These procedural steps 600 are provided in FIG. 6 which include data collection 610 providing an input to data preparation 620, which itself inputs AI/ML training data to AI/ML training 630 and AI/ML inference 640. AI/ML training 630 also inputs to AI/ML model management 650, which itself inputs to AI/ML inference 640 and AI/ML continuous operation 660. AI/ML continuous operation 660 also inputs to AI/ML inference 640. AI/ML inference provides input to AI/ML assisted solutions 670 (for example configuration management 671, control actions 672 and policy 673) which may feed into AI/ML continuous operation 660. However data preparation in ORAN is an implementation specific component, and not a service provided in response to a particular request from a consumer.

Within the field of analytics data preparation as hereinbefore described, the disclosed data preparation configuration entity and data preparation entity provide a data preparation capability as a new SEAL service, e.g. SEAL Data Preparation Management (DPM), to provide the necessary data preparation configuration of raw data based on the request from the consumer (SEAL service or external application).

Such SEAL DPM service may have also a client counterpart at the UE side (i.e. a DPM-C), which can be configured to prepare locally data from the UE(s) side before sending to the server (the DPM-S). For example, L2/UE application measurements (such as QoS/radio performance measurements e.g. channel losses, latency) can be prepared at DPM-C to make sure that the quality of data is acceptable before sending to DPM-S. This will save both signaling and complexity at the server side. FIG. 7 illustrates generally an architecture 700 embodying a VAL layer 701 and a SEAL DPM layer 702. A VAL UE 710 is shown comprising a VAL client 711 interfacing with a VAL server 720 via a 3GPP network system 730. The architecture 700 also illustrates how a SEAL DPM Client 712 in the VAL UE 710 interfaces with the VAL client 711, but also with a DPM Server 740 via the 3GPP network system 730. The DPM Server 740 is also shown interfacing with the VAL Server 720 and the 3GPP network system 730 itself. The DPM Server 740 is also shown interfacing with ADAES 750, NSCE-S 760 and SEALDD-S 770. The VAL UE 710 is shown in SEAL with ADAE-C 712, NSCE-C 713, SEALDD-C 714. In certain implementations, the SEAL DPM layer 702 may control the data preparation which can be a new capability of SEALDD layer or a new layer or a co-deployed module with DPM. Whilst illustrated as a separate layer 702, the SEAL DPM may be deployed within SEALDD or any other existing enablement layer and/or can also be deployed as a trusted 3^{rd} party application function (e.g. DCAF). DPM can be a function, service, server, client or combination thereof, for instance.

The SEAL DPM layer 702 includes at least one of the following operations: configure the data preparation parameters; select data set or records; analyse the data; data exploration; data processing; data formatting; and prepare data. Each of these operations is further explained below.

Configuring the data preparation parameters may involve pre-configuring parameters by OAM, VAL layer, ECSP/CSP, MNO, and then based on the configuration performing the remaining operations.

Selecting data set or records comprises selecting from certain data sources or type of data source (allowing a good fix of data from different sources for completeness) as indicated in a received Event ID or e.g. Analytics ID or Analytics type, i.e. related to the analytics job that prepared data is for. The selection of data sources or records may also be influenced by the expected waiting time indicated by the consumer.

Analyzing the data comprises analyzing for information extraction regarding the: central tendency and variation, i.e., what values shall be expected mostly and what would be the variation, e.g., extracting the data mean, variation, minimum, maximum, and other statistical properties included the distribution of data; Relative effect among variables or features, how the values of one variable or feature changes in relation with another; and/or amount of data adequate for the requested task, (i.e., Analytics ID).

Data exploration comprises exploring to identify if the collected data faces quality issues including: Anomalies due to errors in data source, i.e., faults or security incidents, or data transfer errors; missing values such as a) in terms of the percentage per feature (a feature is an individual measurable property or characteristic of the data that feed an AI/ML algorithm, e.g., UE type, mobility type, etc.) or with respect to a specific value range, or other data conditions, and b) reasoning, e.g., integration errors or processing errors if data preparation need to generate new values for usage of the AI/ML algorithm or indicate data unavailability from data sources; Irregular cardinality, where there is a need to check for a) feature errors, (e.g., different data sources may indicate the same feature using different names or IDs), b) impractical features, e.g., with value of 1 (i.e., a feature that is identified by the developer but has no practical meaning for the AI/ML algorithm), and c) data that concentrate only on a particular range; and/or outliers that characterize values far beyond the expected range considering values that are a) valid, i.e., correct values, but very different from what expected, or b) invalid, i.e., incorrect noise values that are inserted due to an error.

Data processing comprises carrying out the instructions or configuration given by the VAL layer or the DPM configurator (e.g. OAM) related to: Execute method to augment missing data considering the a) indicated range, b) percentage and volume of missing data and iii) method for augmenting missing data; Execute policy to perform data cleaning to get rid of outliers and random errors by i) removing data or ii) introduce a weight to reduce their impact of certain data; Indicate optionally the expected performance impact on AI/ML model in case input data from a particular source is still missing, i.e., even after interacting with VAL/customer/OAM, due to incapability of the selected method to retrieve the data; and/or simplify indicated data.

Data formatting converts data into the appropriate shape needed by the AI/ML model.

Prepare data sets comprises preparing data sets for training, validation, and testing e.g. according to the instructions given by the VAL customer/OAM.

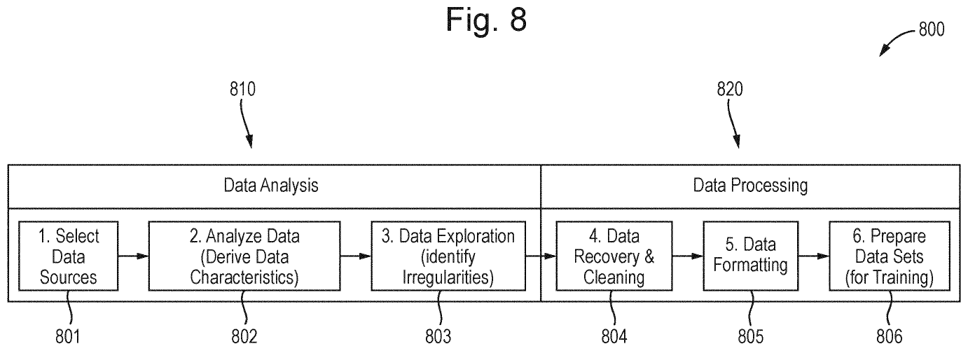

The sequence 800 of the operations related to the data preparation is illustrated in FIG. 8, corresponding to the steps described above. The steps are grouped into data analysis 810 and data processing 820. The data analysis 810 steps include selecting data sources 801, analyzing data 802 and data exploration 803. The data processing 820 includes data recovery and cleaning 804, data formatting 805, and preparing data 806. Although the Figure shows a certain sequence of steps this sequence can be also differently executed, e.g., steps 804 and 805 can be reversed allowing the data processing first before the data recovery and cleaning.

The DPM as disclosed herein may be implemented by a data preparation configuration entity in a wireless communication system, comprising a transceiver arranged to receive a request for application layer data processing management, the request comprising a requirement for managing raw data from at least one data source; and a processor arranged to configure at least one parameter of a data preparation configuration based on the request for application layer data processing management, the at least one parameter comprising information for preparing the required data.

The DPM may be provided by a third party trusted entity/external entity to the core network of the wireless communication system, in particular provided by an enablement/application entity. An application layer in this context includes an application enablement layer and/or an edge enablement layer. Data processing management examples include preparation management and collection management.

A requirement for managing raw data corresponds to a requirement for collecting and processing data related to a specific event. Such requirement may be accompanied with performance requirements related to the delivery of data, the required data type and data characteristics. The event itself may be an analytics event or a data collection even or a data processing event.

In some embodiments, the transceiver is further arranged to receive raw data from the at least one data source; the processor is further arranged to process the raw data based on the data preparation configuration; and the processor is further arranged to control the transceiver to transmit a report indicating a data quality issue of the raw and/or processed data.

Raw data can be application data, network data and/or user data. The term ‘raw’ is intended to mean unprocessed or non-analyzed data. By way of example raw data may be radio measurements, application performance monitoring outputs, application QoS/QoE data, management data, core network data, edge computing data (e.g. edge load or performance data), computational load measurements, or any combination thereof.

A data quality issue can be defined based on the evaluation of the raw data. For example an issue can be due to missing data or irrelevant data or data anomalies.

In some embodiments, the processor is further arranged to perform a data recovery operation based on a data quality issue of the raw data.

In some embodiments, the data recovery operation comprises checking for missing data and/or low quality data and based on the checking, controlling the transceiver to request supplementary data from the at least one data source, performing additional processing using additional data sources and/or flagging the data as low quality.

In some embodiments, the processor is further arranged to control the transceiver to transmit a subscription request to the at least one data source and/or a data collection coordination entity for performing the data preparation.

In some embodiments, the processor is further arranged to control the transceiver to transmit the processed data.

In some embodiments, the transceiver is further arranged to transmit the data preparation configuration to a data preparation entity.

In some embodiments, the data preparation configuration entity is selected from the list of data preparation configuration entities consisting of: an Operations Administration and Maintenance function, OAM; an edge enablement server; and an application enablement server.

In some embodiments, the processor is further arranged to control the transceiver to transmit a positive or negative acknowledgement in response to the request for application layer data processing management.

In some embodiments, the data preparation configuration entity is for providing data preparation for Artificial Intelligence/Machine Learning, AI/ML, model training and/or inference data for an AI/ML model.

In some embodiments, the at least one parameter comprising information for preparing the required data, comprises information related to at least one of: evaluation of data quality; recovery of missing data; cleaning of data; formatting of data; labelling of data; and separation of data into data sets for one or more AI/ML training and/or inference tasks.

In some embodiments, the request for application layer data processing management is received from a consumer selected from the list of consumers consisting of: a third party application; a VAL server; and an enablement server.

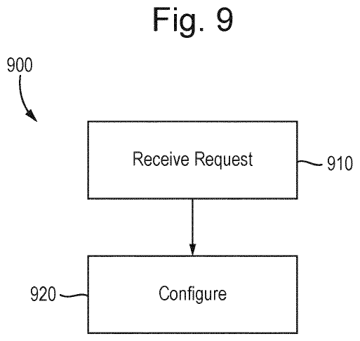

FIG. 9 illustrates an embodiment of a method 900 in a data preparation configuration entity in a wireless communication system.

In a first step 910, a request for application layer data processing management is received. The request comprises a requirement for managing raw data from at least one data source.

In a second step 920, at least one parameter of a data preparation configuration is configured based on the request for application layer data processing management. The at least one parameter comprises information for preparing the required data.

In some embodiments, the method further comprises: receiving raw data from the at least one data source; processing the raw data based on the data preparation configuration; and transmitting a report indicating a data quality issue of the raw and/or processed data.

In some embodiments, the method further comprises performing a data recovery operation based on a data quality issue of the raw data. In some embodiments, the data recovery operation comprises checking for missing data and/or low quality data and based on the checking, controlling the transceiver to request supplementary data from the at least one data source, performing additional processing using additional data sources and/or flagging the data as low quality.

In some embodiments, the method further comprises transmitting a subscription request to the at least one data source and/or data collection coordination entity for performing the data preparation.

In some embodiments, the method further comprises transmitting the processed data.

In some embodiments, the method further comprises transmitting the data preparation configuration to a data preparation entity.

In some embodiments, the data preparation configuration entity is selected from the list of data preparation configuration entities consisting of: an OAM function; an edge enablement server; and an application enablement server.

In some embodiments, the method further comprises transmitting a positive or negative acknowledgement in response to the request for application layer data processing management.

In some embodiments, the method is for providing data preparation for AI/ML model training and/or inference data for an AI/ML model.

In some embodiments, the at least one parameter comprising information for preparing the required data comprises information related to at least one of: evaluation of data quality; recovery of missing data; cleaning of data; formatting of data; labelling of data; and separation of data into data sets for one or more AI/ML training and/or inference tasks.

In some embodiments, the request for application layer data processing management is received from a consumer selected from the list of consumers consisting of: a third party application; a VAL server; and an enablement server.

FIG. 10 illustrates a further embodiment of a method 1000 in a data preparation configuration entity. In this embodiment, a DPM server (as a data preparation configuration entity) based on the consumer request, configures and performs data preparation after subscribing to the data sources to get data and ack as intermediate for the user plane data delivery. The figure shows a VAL UE 1010 comprising a VAL Application Client 1011, a DPM client 1012, and a UE Modem 1013. The figure also shows a SEAL DPM Server 1020. The figure also shows a data source/SEALDD/A-DCCF/DCAF 1030. The figure also shows a consumer (ADAES, NSCE) 1040. The steps of the method 1000 will now be described.

In a first step 1001, a consumer 1040 (VAL server or ADAES/NSCE) sends a subscription request or request to SEAL DPM 1020 to initiate data preparation in a certain area and time or for a certain application/vertical service (e.g. V2X platooning). The request may include Event ID, Consumer ID, Data required, service profile, area and/or time.

In a second step 1002, SEAL DPM 1020 authorizes the request and determines the data collection and preparation requirements based on the type of request (e.g. per analytics ID) or based on the data sources involved (e.g. UEs, AF, . . . ).

In a third step 1003, SEAL DPM 1020 send a response (ack/nack) to consumer 1040.

In a fourth step 1004, SEAL DPM 1020 subscribes to data sources 1030 and optionally subscribes to SEALDD to receive data on behalf of the consumer 1040 (VAL server or ADAES/NSCE) to allow for preparing data. DPM 1020 also provides information on the data collection requirement and configurations (format, frequency, parameters to be measured, thresholds). Data Sources 1030/SEALDD authorize the subscription request and respond with a positive or negative ack. SEAL DPM 1020 then receives data from data sources 1030/SEALDD.

In a fifth step 1005, SEAL DPM 1020 prepares data received from the data sources 1030 and in particular it checks for missing data, low quality data, etc. for one or more sources, and based on the checking it may either request supplementary data/perform some additional processing or flag the data as low quality data. Depending on the data collection delay requirements, the decision of DPM 1020 may have some upper threshold for preparing data to ensure that the overall delay (data source 1030—DPM 1020—consumer 1040) is not exceeded. If no decision is reached the DPM 1030 either sends a failure event or doesn't provide data to the consumer 1040.

In a sixth step 1006, SEAL DPM 1020 sends the processed data to the consumer 1040 (VAL server, ADAES,.) with possible flag in case of low quality (to allow the consumer to reduce confidence level of possible analytics)

In a seventh step, the consumer 1040 receives data and uses them as input for the needed SEAL/VAL capability (e.g. analytics, slice enablement, etc).

The DPM as described herein may be further implemented by a data preparation entity in a wireless communication system, that receives a data preparation configuration. The data preparation entity comprising: a transceiver arranged to receive a data preparation configuration, the data preparation configuration comprising at least one parameter comprising information for preparing required data required from at least one data source, wherein the transceiver is further arranged to receive raw data from the at least one data source; and a processor arranged to process the raw data based on the data preparation configuration; and wherein the processor is further arranged to control the transceiver to transmit a report indicating a data quality issue of the raw and/or processed data.

In some embodiments the processor is further arranged to perform a data recovery operation based on a data quality issue of the raw data. In some embodiments the data recovery operation comprises checking for missing data and/or low quality data and based on the checking, controlling the transceiver to request supplementary data from the at least one data source, performing additional processing using additional data sources and/or flagging the data as low quality.

In some embodiments, the processor is further arranged to control the transceiver to transmit a subscription request to the at least one data source and/or a data collection coordination entity for performing the data preparation.

In some embodiments, the data preparation entity is selected from the list of data preparation entities consisting of: an application enablement server; and an application enablement client.

In some embodiments, the data preparation entity is for providing data preparation for AI/ML model training and/or inference data for an AI/ML model.

In some embodiments, the at least one parameter comprising information for preparing the required data comprises information related to at least one of: evaluation of data quality; recovery of missing data; cleaning of data; formatting of data; and separation of data into data sets for one or more AI/ML training and/or inference tasks.

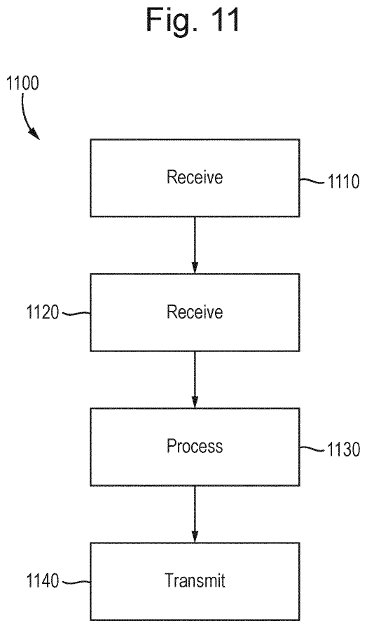

FIG. 11 illustrates an embodiment of a method 1100 in a data preparation entity, the data preparation entity in a wireless communication system.

In a first step 1110, a data preparation configuration is received, the data preparation configuration comprising at least one parameter comprising information for preparing required data required from at least one data source.

In a second step 1120, raw data is received from the at least one data source.

In a third step 1130, the raw data is processed based on the data preparation configuration.

In a fourth step 1140, a report is transmitted indicating a data quality issue of the raw and/or processed data.

Some embodiments further comprise performing a data recovery operation based on a data quality issue of the raw data. In some embodiments the data recovery operation comprises checking for missing data and/or low-quality data and based on the checking, requesting supplementary data from the at least one data source, performing additional processing using additional data sources and/or flagging the data as low quality.

Some embodiments further comprise transmitting a subscription request to the at least one data source and/or a data collection coordination entity for performing the data preparation.

In some embodiments, the data preparation entity is selected from the list of data preparation entities consisting of: an application enablement server; and an application enablement client.

In some embodiments, the method is for providing data preparation for AI/ML model training and/or inference data for an AI/ML model.

In some embodiments, the at least one parameter comprising information for preparing the required data comprises information related to at least one of: evaluation of data quality; recovery of missing data; cleaning of data; formatting of data; and separation of data into data sets for one or more AI/ML training and/or inference tasks.

FIG. 12 illustrates a further embodiment of a method 1200 in a data preparation entity, the data preparation entity in a wireless communication system. In this embodiment, a DPM server configures a DPM client at the UE side for the data sources related to the UE or group of UEs (e.g. for a platoon or a V2X zone), and the DPM client prepares the data to allow some processing and minimizing anomalies for real/near-real time data. In certain cases, it is possible that the DPM server supports by providing additional processing to fix the data quality at the network/server side (using app/network data). The figure shows a VAL UE or group of UEs 1210 comprising local data sources 1211 (app, SEALDD-C, AS/NAS) and a DPM client 1212. The figure also shows a SEAL DPM server 1220. The figure also shows data sources/SEALDD/A-DCCF/DCAF 1230. The figure also shows a consumer 1240 (ADAES, NSCE).

In a first step 1201, consumer 1240 (VAL server or ADAES/NSCE) sends a subscription request or request to SEAL DPM server 1220 to initiate data preparation in a certain area and time or for a certain application/vertical service (e.g. V2X platooning). The request may include an event ID, consumer ID, data requirement, service profile, area and/or time.

In a second step 1202, SEAL DPM server 1220 authorizes the request and determines the data collection and preparation requirements based on the type of request (e.g. per analytics ID) or based on the data sources involved (e.g. UEs, AF, etc).

In a third step 1203, SEAL DPM server 1220 send a response (ack/nack) to consumer 1240.

In a fourth step 1204, SEAL DPM server 1220 configures the required SEAL DPM clients 1212 for the UE related data, the configuration includes how the preparation shall be done and what policies need to be placed if missing/low quality data are found.

In a fifth step 1205, SEAL DPM client 1212 subscribes to UE data sources 1211 (e.g. app, SEAL or SEALDD client, EEC, UE AS/NAS layer functions). DPM client 1212 also provides information on the data collection requirement and configurations (format, frequency, parameters to be measured, thresholds).

In a sixth step 1206, SEAL DPM client 1212 prepares data received from the sources 1211 and in particular it checks for missing data, low quality data, etc, for one or more sources 1211.

In a seventh step 1207, SEAL DPM client 1212 sends the processed data to the consumer 1240 (VAL server, ADAES, other application or edge enablement server) with possible flag in case of low quality (to allow the consumer 1240 to reduce confidence level of possible analytics).

In an eighth step 1208, SEAL DPM server 1220 based on the DPM client 1212 checking it may request supplementary data/perform some additional processing from additional sources 1230 or flag the data and trigger an event towards the consumer 1240.

In a ninth step 1209, the consumer 1240 receives data and uses them as input for the needed SEAL/VAL capability (e.g. analytics enablement, slice enablement, vertical application specific capability, etc).

Data collection at the application layer poses some issues related to the quality of data and the possible data anomalies during the data collection and how these can be repaired, to ensure that the data consumer's requirements (who may be an ECSP/CSP which use this data for analytics, ML training etc) will be met without noticing. This issue is due to the fact, that at the application layer, data can have different formats, granularities, come from different systems/platforms and it is not straightforward how and where the data will be processed before becoming an input to an analytics engine or a SEAL algorithm.

The problem to be solved is how to deal with the situation of preparing the data and configuring the preparation in a way that is optimal based on consumer needs.

This invention introduces a new SEAL service which is used to configure and support the data preparation (analysis and recovery) for application raw data, to derive processed data to be used as inputs for other SEAL services. Such preparation and configuration can be based on the type of consumer and the type of application service/event.

Other alternatives are implementation specific so a consumer of analytics cannot influence the data preparation, a significant step for the performance of analytics, while data preparation process cannot deal with new or customized problems. Especially for 3rd parties that have better knowledge of their own data, an open interface allows them to control the data preparation instead of relying on a preconfigured solution, achieving better analytics results.

The exemplar embodiments provide for data preparation and configuration provided by a new SEAL server, aka SEAL DPM; and the data preparation configuration being provided by a new SEAL server, aka SEAL DPM, whereas the data preparation is handled locally at the UE side. Such embodiment is for scenarios where the data sources provide real time data at the UE side, and the preparation can help providing processed data to the network side, rather than raw data. Additional aspects are provided by the clauses below.
1. A method (at a data preparation configuration entity, e.g. DPM server or OAM) for configuring data preparation, the method comprising: receiving a request for data collection management from an application entity, the request indicating a requirement for data from at least one data source; and configuring at least one parameter for preparing the data collection, based on the request for data collection management, the at least one parameter comprises information for evaluating the data quality for the required data, (some embodiments comprise sending the at least one configured parameter to a data preparation entity).
2. A method for performing data preparation (at a data preparation entity, e.g. DPM server or DPM client), comprising: obtaining at least one configured parameter (from the application enablement entity); receiving raw data from at least one source of data (wherein the source of data can be also a data collection coordination entity); and processing the raw data based on the configured parameter, the processing comprises evaluating the data quality (some embodiments comprise performing data recovery, based on the evaluation of raw data (wherein the data recovery comprises the addition of missing data); and sending a report indicating the data quality of the raw and/or processed data.
3. The method of any one of clauses 1-2, wherein data preparation is used for analytics derivation, (and in particular data are to be used as AI/ML model training and/or inference data for the ML model).
4. The method of any one of clauses 1-2, wherein the entity for configuring and performing data is the same entity.
5. The method of clause 1, wherein the data preparation configuration entity is an OAM function and/or an application enablement entity
6. The method of clause 2, wherein the data preparation entity is an application enablement client and/or server.
7. The method of clause 2, further comprising subscribing to at least one data source and/or data collection coordination entity for performing the data preparation.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document:
3GPP 3rd Generation Partnership Project
5G 5th Generation of Mobile Communication
AI/ML Artificial Intelligence/Machine Learning
ADRF Analytical Data Repository Function
AF Application Function
AnLF Analytics Logical Function
CM Configuration Management
DCAF Data Collection Application Function
DCCF Data Collection Coordination Functionality
DP Data Preparation
KPI Key Performance Indicator
MF Management Function
MFAF Messaging Framework Adaptor Function
MICO Mobile Initiated Connection Only
MnS Management Service
MTLF Model Training Logical Function
NEF Network Exposure Function
NF Network Function
NRF Network Repository Function
NWDAF Network Data Analytics Function
OAM Operations, Administration and Maintenance
ORAN Open RAN
PM Performance Measurement
QoE Quality of Experience
RAN Radio Access Network
SBA Service Based Architecture
UDM User Data manager
UDR User Data Repository
UE User Equipment
DPM Data Preparation Management

1. An apparatus in a wireless communications system, comprising
at least one memory; and
at least one processor coupled with the at least one memory and arranged to cause the apparatus to:
receive a request for application layer data processing management, wherein the request comprises a requirement for managing raw data from at least one data source; and
configure at least one parameter of a data preparation configuration based at least in part on the request for application layer data processing management, wherein the at least one parameter comprises information for preparing required data.

2. The apparatus of claim 1, wherein the at least one processor is further arranged to cause the apparatus to:
receive raw data from the at least one data source;
process the raw data based on the data preparation configuration; and
transmit a report indicating at least one of a data quality issue of the raw data or a data quality issue of the processed data.

3. The apparatus of claim 2, wherein the at least one processor is further arranged to cause the apparatus to perform a data recovery operation based at least in part on the data quality issue of the raw data.

4. The apparatus of claim 3, wherein to perform the data recovery operation, the at least one processor is further arranged to cause the apparatus to:
check for at least one of missing data or low quality data;
request, based at least in part on the check, supplementary data from the at least one data source; and
perform additional processing using at least one of additional data sources or flagging the data as low quality.

5. The apparatus of claim 4, wherein the at least one processor is further arranged to cause the apparatus to transmit a subscription request to at least one of the at least one data source or a data collection coordination entity for performing the data preparation.

6. The apparatus of claim 5, wherein the at least one processor is further arranged to cause the apparatus to transmit the processed data.

7. The apparatus of claim 1, wherein the at least one processor is further arranged to cause the apparatus to transmit the data preparation configuration to a data preparation entity.

8. The apparatus of claim 1, wherein the apparatus is selected from a list of data preparation configuration entities including an operations and maintenance (OAM) function, an edge enablement server and an application enablement server.

9. The apparatus of claim 1, wherein the at least one processor is further arranged to cause the apparatus to transmit a positive acknowledgement or a negative acknowledgement in response to the request for application layer data processing management.

10. The apparatus of claim 1, wherein the at least one processor is further configured to cause the apparatus to provide data preparation for at least one of artificial intelligence/machine learning (AI/ML) model training or inference data for an AI/ML model.

11. The apparatus of claim 1, wherein the at least one parameter comprises information related to at least one of evaluation of data quality, recovery of missing data, cleaning of data, formatting of data, labelling of data, or separation of data into data sets for one or more artificial intelligence/machine learning (AI/ML) model training or inference tasks.

12. The apparatus of claim 1, wherein at least one processor is further arranged to cause the apparatus to receive the request for application layer data processing management from a consumer selected from a list of consumers including a third party application, a VAL server, or an enablement server.

13. An apparatus in a wireless communication system, comprising:
at least one memory; and
at least one processor coupled with the at least one memory and arranged to cause the apparatus to:
receive a data preparation configuration, wherein the data preparation configuration comprises at least one parameter comprising information for preparing required data required from at least one data source;
receive raw data from the at least one data source;
process the raw data based on the data preparation configuration; and
transmit a report indicating a data quality issue of the raw and/or processed data.

14. The apparatus of claim 13, wherein the at least one processor is further arranged to cause the apparatus to perform a data recovery operation based on a data quality issue of the raw data.

15. The apparatus of claim 14, to perform the data recovery operation, the at least one processor is further arranged to cause the apparatus to:
check for at least one of missing data or low quality data;
request, based at least in part on the check, supplementary data from the at least one data source; and
perform additional processing using at least one of additional data sources or flagging the data as low quality.

16. The apparatus of claim 13, wherein the at least one processor is further arranged to cause the apparatus transmit a subscription request to at least one of the at least one data source or a data collection coordination entity for performing the data preparation.

17. The apparatus of claim 13, wherein the apparatus is selected from a list of data preparation entities including an application enablement server, and an application enablement client.

18. The apparatus of claim 13, wherein the at least one processor is further configured to cause the apparatus to provide data preparation for at least one of artificial intelligence/machine learning (AI/ML) model training or inference data for an AI/ML model.

19. (canceled)

20. A method performed by a device in a wireless communication system, the method comprising:
receiving a request for application layer data processing management, wherein the request comprises a requirement for managing raw data from at least one data source; and
configuring at least one parameter of a data preparation configuration based at least in part on the request for application layer data processing management, wherein the at least one parameter comprises information for preparing required data.

21-31. (canceled)

32. A method performed by a device in a wireless communication system, the method comprising:
receiving a data preparation configuration, wherein the data preparation configuration comprises at least one parameter comprising information for preparing required data required from at least one data source;
receiving raw data from the at least one data source;
processing the raw data based on the data preparation configuration; and
transmitting a report indicating a data quality issue of the raw and/or processed data.
